(19) United States
(12) Patent Application Publication
(10) Pub. No.: US 2006/0011175 A1
(43) Pub. Date: Jan. 19, 2006

(54) Fuel-saver

(76) Inventor: Otto Regner, Troy, MI (US)

Correspondence Address: OTTO REGNER, 5491 WINCHESTER, TROY, MI, 48085, US

(21) Appl. No.: 10/889,604

(22) Filed: Jul. 13, 2004

(51) Int. Cl. F02B 51/00

(52) U.S. Cl. 123/536

(57) ABSTRACT

The electronic wave generator and amplifier will first enable size reduction of air, oxygen and gaseous hydrocarbon fuel molecules in such a way that most molecules will self-exist for just a few milliseconds and will then consolidate into larger oxidizing molecules for combustion. These enlarged molecules will enhance the stoichiometric oxidation and maximize energy generation. Air pollution will be reduced and will thus lessen environmental impact. In addition, carbon in the lubrication oil will infuse, nano-plate, electrochemically into bearing, cylinder, and piston wall surfaces and will help reduce wear and friction, thus extending longevity of engines, turbines, gears when applicable.

These add-on devices are used to improve internal combustion and reduce exhaust emissions in automobile gas engines, diesel engines, jet engines, gas turbines, (heavy) oil and gas burning steam boilers and furnaces. The improved heat-power generation results in increased travel mileage and more watts/work per unit of fuel.

On gasoline, natural gas and hydrogen engines with internal spark plug ignitions, the spark plug high voltage coils and cables induce current into the patent's device-looped hookup wires (see FIGS. 1, 2 and 3). The induced current is modulated and fed back by the “fly back” (EMF) induction network circuits. This counter electronic magnetic force inductively flows back to all engine spark plug cables and their associated electrodes and to the air inlet duct antenna electrodes. The engine air inlet and the open valves provide wave guides by directing a multitude of electric induced waves to the combustion chambers. During the fill up of air and fuel into combustion chambers, the electronic waves induce positive and negative charges to molecules and maximize the oxidation of molecular and atomic reaction. That stimulation of oxygen, hydrogen and carbon atoms ensures a complete burn and improves the heat generation and energy extraction. Equally beneficial, the harmful exhaust gases are greatly reduced, thus improving the environment for all of us.

Other patents use ionization for specific purposes, but the voltage levels used are much higher, in the 4000 and higher voltage ranges. This patent, contrary to other patents in this field, does not require high voltage ionization. This patent's device causes a loose but enhanced sorting and mixing of cations and anions (positive and negative ions) resulting in a homogeneously smooth atomic level molecular oxidation.

Field tests repeatedly have shown an energy output improvement of up to 38% with the described patented wave-shaping. In addition, the exhaust gases show minimal (less than 1 part per million) hydrocarbons left over. These performance tests were much better than originally expected.

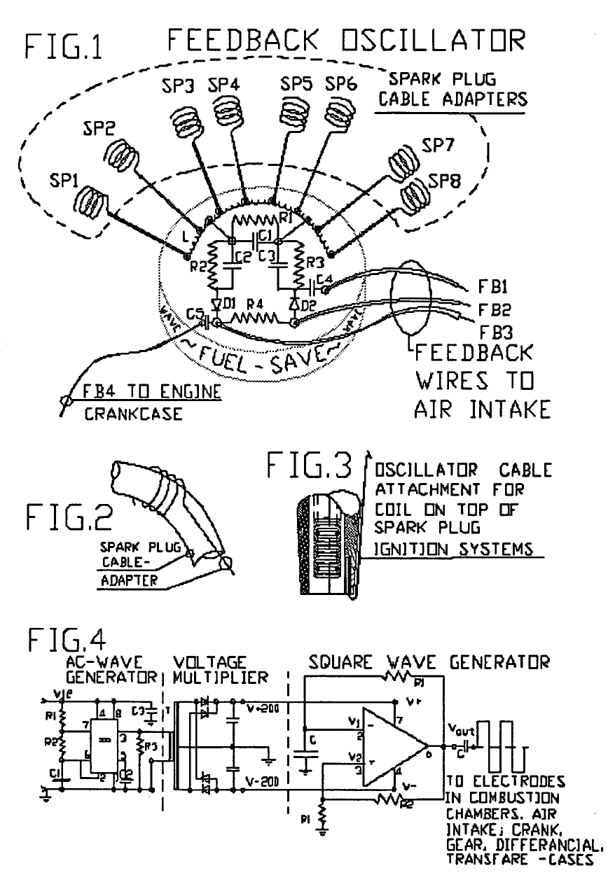

This patent's wave shaping can be used in almost all combustion-type power generators and engines. Installations include those with electrodes/antennas mounted at the air inlet and inside the combustion chambers. If the engines have a startup spark plug, then the square wave feeding cable will be inductively connected as shown in FIG. 2 and 3. Internal-combustion engines, gas turbines, and furnace manufacturers are advised to install this patented feature into combustion chambers and at air inlets to enhance the oxidation and the efficiency of their products and to help clean up the environment.

There are additional benefits related to this patent. Carbon deposits in automobile combustion chambers will slowly disappear within a few hundred miles driven because of a more complete combustion and the catalytic diffusion of electro magnetic radiation on carbon. When carbon deposits disappear and lubrication oil stays clean or becomes clean again, the physical wear between moving parts decreases to practically nothing. The wearing surfaces become harder and much more wear resistant by the nano-plating effect of the electromagnetic waves. The friction decreases between pistons and cylinders as well. Because of the cleaner and homogeneous combustion, a lesser octane rated gasoline can be used safely without losing engine performance. In time, fuel additives can be reduced and catalytic converters will become obsolete with clean-burning gasoline engines. Another benefit is the ability to reduce the engine's idle-speed.

In summary, the attributes of this invention are better gas mileage with a lower additive and octane fuel, a cleaner engine with less friction and pollution, and a longer engine life. Tests have shown that savings in energy costs would be reduce by 20 to 30%. The cleaner environment will also result in better health for the public with subsequently lower medical costs.

What is claimed is:

1. A combustion enhancing electronic device that can easily be attached to spark plugs, see FIG. 3, and ignition cables, see FIG. 1, 2 and 6, as commonly found on gasoline (automobile) engines. The device's feedback cables are attached to the engine's associated air intake. See FIG. 6.

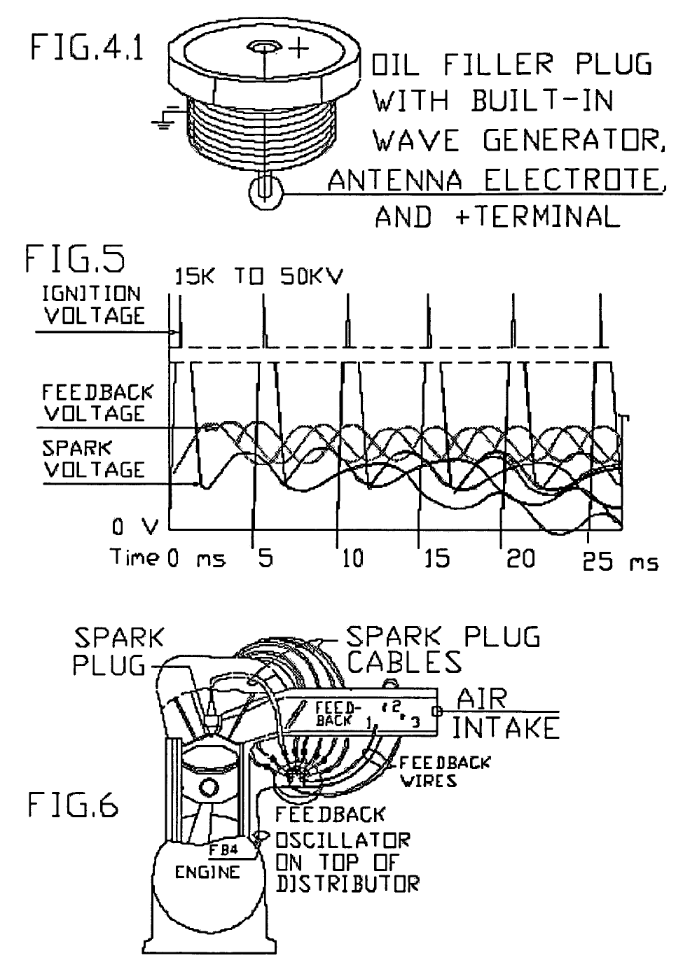

2. A self-contained wave generator, see FIG. 4, that makes square waves and feeds them by insulated wires and electrons/antennas into the combustion chambers and their associated air intakes. They may be used on diesel engines, jet engines, gas turbines, steam pressure boilers that burn gas, oil or coal and other oxidizing combustion equipment, ovens, burners and furnaces.

3. As specified in claim 1, this is a self-contained electronic feedback oscillator that inductively collects stray spark currents from spark plug cables, multiplies the induced voltage by oscillating it and simultaneously feeds it in a phase-delayed manner to all other spark plugs and feedback electrodes.

4. The system, as described in claim 2, may be powered by a car's battery. It should be connected to the engine's power-on contact and protected by a fuse. It will provide radiating inductive square waves and their associated harmonic waves to enhance the molecular atomic-level oxidation/combustion.

5. As shown in FIG. 5, the spark plug ignition voltage is customarily around 15,000 to 50,000 Volts, but the spark voltage, after ionization starts, is much less and goes to a low to negative ripple. However as claimed under #5, the induction current will drive the feedback oscillator voltage to plus/minus 15 to 200 volts depending on engine speed, number of cylinders, ignition design and cable induction.

6. It is claimed here in #6 that the spark plug insulated electrode and the added electro-magnetically induced voltage at the air intake will enhance the molecular and atomic level reactive oxidation in ignition combustion engines as shown in FIG. 6.

7. It is claimed here in #7, that insulated electrodes, similar to spark plugs, must be inserted into combustion chambers in addition to the air intake electrodes. Here in #7, a square or saw tooth wave generator, as shown in FIG. 4, 4.1 will enhance the combustion and the energy efficiency and will decrease the exhaust gas pollutions.

8. With jet engines, gas turbines, furnaces and other combustion engines and burners, similar to claim #7, additional insulated electrodes must be installed into the fore-combustion burn chamber and into the air intake. However, here the multiple electrodes are installed radially to cover a ring area with magnetic waves.

9. What is claimed in #9 is the installation of additional insulated electrodes into the lower part of the ventilation duct or engine crankcase, gear and differential cases and supplying it with electromagnetic waves from the oscillator as shown in FIG. 1, or from a wave generator as shown in FIG. 4, 4.1. By doing this, not only will carbon deposits be dissolved and the lubrication oil regenerated and cleaned effectively, but the cams, cranks, piston cross-pins, gears and bearings will be nano-plated effectively with the help of electromagnetic waves. The result is the life extension with all-around cost reduction of these machines and equipments.
